(19) United States
(12) Patent Application Publication
(10) Pub. No.: US 2014/0329503 A1
(43) Pub. Date: Nov. 6, 2014

(54) METHOD, MODULE OF ACCESS CONTROLS AND A UE COMPRISING THE SAME

(71) Applicant: ALCATEL LUCENT, Paris (FR)

(72) Inventor: Yun Deng, Shanghai (CN)

(73) Assignee: ALCATEL LUCENT, Paris (FR)

(21) Appl. No.: 14/356,712

(22) PCT Filed: Nov. 6, 2012
(86) PCT No.: PCT/IB2012/002666

§ 371 Date: May 7, 2014

(30) Foreign Application Priority Data
Nov. 7, 2011 (CN) 201110348979.8

(51) Int. Cl. H04W 12/08

(52) U.S. Cl. CPC H04W 12/08
USPC 455/411

(57) ABSTRACT

There is no detailed scheme implementing access controls using extended access barring (EAB) in the current technology. The invention provides a method, module and UE of implementing access controls, the method comprises the following steps: b. determining (104, 105) whether the UE has a special access level which is valid and not barred: when having, determining the UE can access a current cell; d. determining (103) whether a system information block comprises extended access barring (EAB) parameters of the UE, when comprising: e. determining (116-110) whether the UE can access the current cell based on extended access barring, according to the extended access barring (EAB) parameters of the UE. The invention provides a method of implementing access controls based on extended access barring.

### TECHNICAL FIELD

The invention relates to mobile communication technologies, especially relates to a method and a UE implementing access controls.

### BACKGROUND OF THE ART

The access control must be implemented when a UE accesses a network, for determining whether the UE can initiate a service request, in order to avoid leading to overload in the network side, such as random access overload or signaling overload. In universal mobile telecommunications system (UMTS for short) and long term evolution (LTE for short) system, the UEs may be classified with 16 access classes (AC), wherein, AC 0˜9 belong to ordinary classes, which are randomly allocated to terminals; AC 10 indicates emergency services, which won't be allocated to the terminals; AC 11 is used for network operation; AC 12 is for safety services; AC 13 is for public service categories, e.g. water, gas suppliers; AC 14 indicates emergency services; and AC 15 indicates an operation staff. A terminal may be configured with one of AC 0˜9 and with one or multiple of AC 11˜15, and these configuration information is stored in the universal subscriber identity module (USIM for short). The network side in UMTS and LTE will broadcast system information which comprises access class barred (ACB for short) parameters, respectively for different access classes. The configuration mode of the access class barred parameters is enumeration type which comprises two types of barred and not barred, or a usage barring factor. If a UE needs to initiate a service request, first the UE needs to determine whether it can immediately initiate a service request according to access class barred parameters broadcasted by the access cell.

With the rapid development of mobile communications, it needs an “internet of things” to achieve a wide range of automatic information collection, so it needs to introduce a large amount of machine type communication devices (MD for short) in the network. Because of the large number of these devices, which far exceeds the quantity of current UEs, the network side introduces extended access control (EAB) mechanism, in order to avoid signaling overload or random access overload, etc. The UE applicable for extended access barring (UE configured with EAB) needs to determine whether it can access the network and initiate a service request according to the extended access barring parameters broadcasted by the network.

Based on the current technology, the network side broadcasts access class barred parameters and extended access barring parameters via system information, and the UE needs to implement access control when accessing the network. For an ordinary UE (UE not configured with extended access barring), it uses the method of implementing access controls which is specialized in the current protocol. While for the UE applicable for extended access barring, when it initiates the delay tolerant service or called as low priority service, it's not determined in the art that how to implement access control in detail. Now some detailed requirements of extended access barring parameters configuration have been defined, such as that the extended access barring parameters use the enumeration information cells (comprising barred and not barred), and the network side configures 1 bit cell of barred or not barred respectively for each access class of UEs; the network side may configure corresponding extended access barring parameters for categories of UEs. But there's no existing scheme of the detailed procedure for the UE's implementation of access control. Since the current method implementing access controls according to access class barred doesn't need to consider the access type of UEs, and doesn't need to consider the reason of access failure and other factors, the current scheme of access control can't be applied for the scheme implementing access controls according to extended access barring.

### SUMMARY OF THE INVENTION

The technical problem the invention to solve is to provide a method and a UE of implementing access controls, and an access determination scheme while a UE initiates delay tolerant services.

For solving the above technical problems, one aspect of the invention provides a method of implementing access controls in a UE, wherein, the method comprises the following steps: b. determining whether the UE has a special access level which is valid and not barred: when having, determining the UE can access a current cell; d. determining whether a system information block comprises extended access barring (EAB) parameters of the UE, when comprising: e. determining whether the UE can access the current cell based on extended access barring, according to the extended access barring (EAB) parameters of the UE.

The merit of this aspect is to provide a method of access control based on extended access barring.

“Whether a system information block comprises the extended access barring (EAB) parameters of the UE” means that whether the system information block comprises the extended access barring parameters corresponding to the network selected by the UE; or means that whether the system information block comprises the extended access barring parameters.

Further, the step e comprises the following steps:

i. determining whether the system information comprises the extended access barring parameters relevant with the category corresponding to the UE;

ii. if not comprising, determining whether the system information comprises extended access barring parameters applicable for the UE;
if the determining result of the step i is comprising, or the determining result of the step ii is comprising, then, applying the extended access barring parameters to determine whether the UE can access the current cell;
if the determining result of the step ii is not comprising, then, determining the UE can access the current cell.

Preferably, the applicable extended access barring parameters comprise the extended access barring parameters covering the category corresponding to the UE.

The merit of this further embodiment is that it can select corresponding extended access barring parameters for the UE.

Further, the method still comprises steps:
a. an access stratus receiving a service request from an upper stratus;

when the step e determines the UE can not access the current cell, the method still comprises:
f. informing the upper stratus of the reason of refusing access based on the extended access barring.

Further, when the determining result of the step b is not having, continuing the step d or step e, or applying an access class barred (ACB) to determine whether the UE can access the current cell;

when the determining result of the step d is not having, continuing to apply the access class barred (ACB) to determine whether the UE can access the current cell;

after the step e determines the UE can access the current cell based on the extended access barring, continuing to apply the access class barred (ACB) to determine whether the UE can access the current cell.

In this embodiment, after the access control based on extended access barring, the access control based on access class barred is implemented, and the access control process is further completed.

Further, the method still comprises the following steps between the step b and step d:

c. applying an access class barred (ACB), and determining whether the UE can access the current cell based on the access class barred;
when determining the UE can access, continuing the step d;
when determining the UE can not access, informing the upper stratus of the reason of refusing access based on the access class barred.

In the embodiment, before the access control based on extended access barring, the access control based on access class barred is implemented in advance, and the access control process is further completed.

Further, the access stratus of the UE informs its non-access stratus of the failure reason of access control: failure determining of access based on extended access barring, or failure determining of access based on access class barred. The non-access stratus of the UE determines a minimum time for which re-initiating the service request needs to wait, according to the reason of refusing access.

The merit of this embodiment is that it can reduce the service denying rate of service request, so as to save overhead.

Further, the method still comprises the following steps before the step b:

determining whether an access timer is in a timing state;
when it is not in the timing state, implementing the step b and the subsequent steps; otherwise, determining that the UE can not access the current cell;
wherein, the access timer comprises at least one timer of the following:
   an waiting time timer;
   an access barring timer, configured for delay tolerance services;
   an access barring timer, configured for UE-initiated data services;
   an access barring timer, configured for UE-initiated signaling services.

Further, the UE comprises the UE applicable for extended access barring, and the service request comprises delay tolerant service.

Correspondingly, from the view of products, a second aspect of the invention provides an access control module used for the UE, wherein, the access control module comprises the following components:
a first determining unit which is used for determining whether the UE has a special access level which is valid and not barred: when having, determining the UE can access a current cell;
a second determining unit which is used for determining whether a system information block comprises extended access barring (EAB) parameters of the UE;
a third determining unit which is used for determining whether the UE can access the current cell based on extended access barring, according to the extended access barring parameters of the UE, when the second determining unit determines comprising.

And, a third aspect of the invention provides a UE comprising an access control module according to the second aspect.

The present scheme applies for the extended access barring (EAB) UE, when initiating the delay tolerant service, the network side may implement access control to the UE to solve the access determination problem when this kind of UE accessing the network; at the same time, the scheme re-uses a partial content of the current protocol to reduce modification to the protocol.

### BRIEF DESCRIPTION OF DRAWINGS

By reading the detailed description of unlimited embodiment referring to the following drawings, other features, purposes and merits of the invention will be clearer:

FIG. 1 shows a method diagram of implementing access controls in a detailed embodiment 1;

FIG. 2 shows a subordinate relationship diagram of categories of the UE.

FIG. 3 shows a method diagram of implementing access controls in a detailed embodiment 2.

### DETAILED DESCRIPTION OF THE EMBODIMENTS

The following will elucidate the invention in detail by describing the detailed embodiments. It needs to note that the embodiments and the features thereof may be combined with each other, in the case of no conflict.

### Detailed Embodiment 1

In the LTE system, the UE is in the idle state. The USIM of the UE is configured with an valid extended access barring, such as that the extended access barring configuration may be set as true. Besides, the USIM of the UE indicates the access level of the UE is 8 and 11.

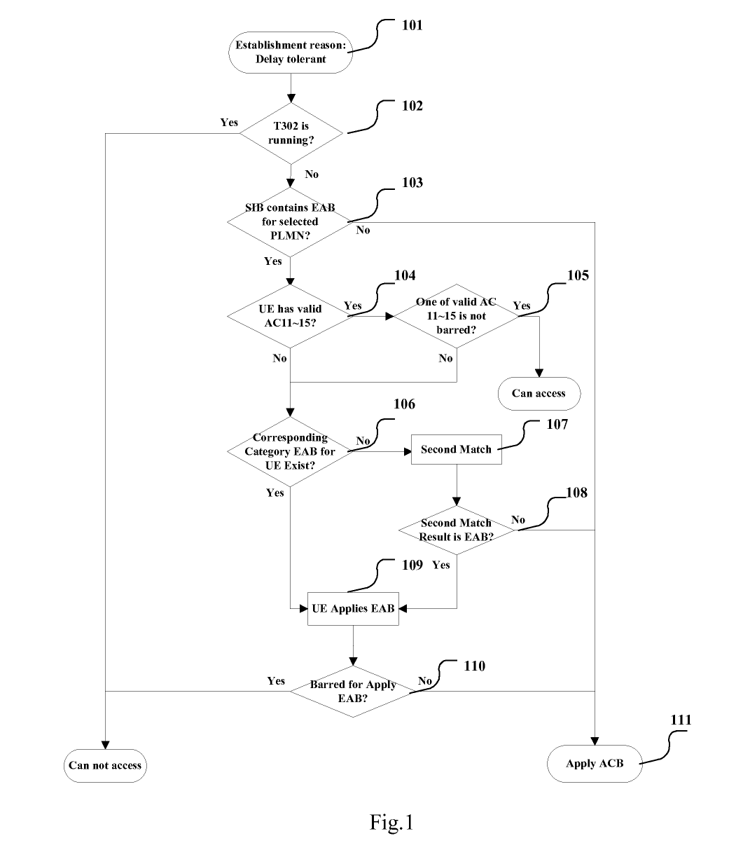

When the UE needs to initiate a delay tolerant service, or a low priority service, the non-access stratus (NAS for short) of the UE sends to the access stratus (AS) of the UE an establishment cause of delay tolerance or low priority. The process of implementing access determination in the AS of the UE is illustrated in FIG. 1.

Step 101: the AS of the UE receives the service request of its upper stratus (NAS), and the establishment cause of the service is delay tolerance.

Step 102: the UE determines whether the waiting time timer (T302) is running, if running, the UE considers access to the cell as barred; if T302 isn't running, the UE implements the step 103.

Here it needs to note that T302 is the timer defined in the current protocol, when accessing the network, if the UE receivers RRC connection refusing signaling which comprises an information cell of wait time or extended wait time, the UE needs to start the timer T302 (the value equals the value of wait time or extended wait time). In release 10, the UE applicable for extended access barring can only initiate emergency services and delay tolerant services, so usually T302 doesn't start, and the step 102 may be not implemented while the step 103 may be implemented directly.

In the later version of the protocol, the UE applicable for extended access barring may initiate other types of services, such as mobile initiating data, or mobile initiating signaling etc., and the T302 may start. In this case the step 102 needs to be implemented. And there are corresponding access barring timer (T303, T305) for mobile initiating data or mobile initiating signaling, then the UE needs to determine in the step 102 whether T302, T303 or T305 is running If one of them is running, it is determined that the UE can not access the current cell.

Besides, the protocol may set a new access barring timer for delay tolerant service, then the step 102 still needs to determine whether the timer is running: if running, the UE can't access the current cell.

103: the UE determines whether a system information block (SIB) comprises the extended access barring parameters corresponding to the network selected by the UE, or comprises extended access barring parameters: if yes, then implementing the step 104, otherwise implementing the step 111.

Here the network selected by the UE means the network to which the cell selected by the UE belongs, the system information of the selected cell (i.e. current resident cell) comprises one or multiple public land mobile network (PLMN for short) identification, the UE selects one PLMN when attaching. The NAS of the UE determines the PLMN selection according to the configuration parameters in the USIM. When a cell broadcasts multiple PLMN identifications, which is as called network sharing, the network side may broadcast a set of independent extended access barring parameters for each network, or configure a set of parameters for all networks. If the network side broadcasts a set of independent extended access barring parameters for each network, then the UE needs to determine whether the extended access barring parameters corresponding to the selected network exist, if existing, then implementing the step 104.

Step 104: the UE determines whether it comprises valid AC11˜15, if yes, then implements the step 105; otherwise implements the step 106.

Step 105: the UE determines whether at least one of valid AC11˜15 is not barred, if yes, the UE considers the current cell is not barred, the initial access control of the UE is successful, then the UE can initiate random access, establish radio resource control (RRC for short) connection in the cell and conduct services; if the UE finds all the valid AC 11˜15 are barred, the UE needs to implement the step 106.

Here the UE implements the determination based on the AC-barring for special AC (i.e. AC 11˜15) broadcasted in the system information, and if the UE finds the valid AC 11˜15 are barred, it needs to implement the step 106.

Here it needs to note that if the system information doesn't broadcast the AC-barring parameters for special AC, the UE considers the current cell is not barred.

In other embodiment, if the UE finds all valid AC 11˜15 are barred, the UE may implements the step 111 directly.

It's worth noted that the position of the step 103 and the positions of 104, 105 may be interchanged, i.e. first determining whether there's valid and not barred AC, and when not having implementing the determination of the step 103.

Step 106: the UE determines whether the extended access barring parameters corresponding to the category of the UE exists, if existing, implementing the step 109; otherwise implementing the step 107.

Here the definition of the category of the UE comprises:

Category A: terminal configured applicable for extended access barring;

Category B: terminal configured applicable for extended access barring and not in HPLMN (Home Public Land Mobile Network) and EHPLMN (Equivalent Home PLMN).

Category C: terminal configured applicable for extended access barring and not in HPLMN, EHPLMN and preferred PLMN.

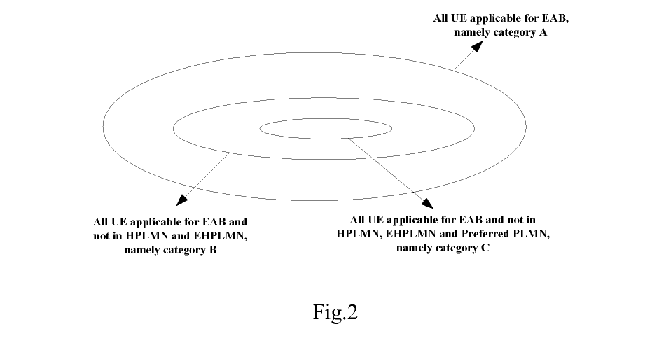

The USIM of the UE stores the identification information of signed HPLMN, EHPLMN and preferred PLMN, the UE will select PLMN when accessing the network, and the UE may determine its category according to the PLMN identification and HPLMN, EHPLMN and preferred PLMN in the USIM. FIG. 2 shows the subordinate relationship among the three categories, it may be seen that the range of the category A is larger than the category B; while the range of the category B is larger than the category C. If there's no preferred PLMN, the range of the category B and C are the same. The UE needs to match the most suitable category, if some UE belongs to both the category A and the category B, but not the category C, according to the rule of most matching, the UE belongs to the category B.

In the step, the UE depends on the extended access barring parameters broadcasted in the system information: if it comprises the extended access barring parameters corresponding to its category, the UE implements the step 109. The extended access barring parameters broadcasted in the system information means the extended access barring parameters corresponding to PLMN selected by the UE.

Step 107: the UE needs to implement a second match. The purpose of the second match is to find the extended access barring parameters applicable for the UE, the UE needs to apply the extended access barring parameters with a larger category with a range closest to its category. Such as if the system information doesn't comprise the extended access barring parameters corresponding to category C, for the UE of the category C, it needs first to match the extended access barring parameters corresponding to the category B; if the system information comprises the extended access barring parameters corresponding to the category B, the UE of the category C applies the extended access barring parameters; if the system information doesn't comprise the extended access barring parameters corresponding to the category B, the UE needs to match the extended access barring parameters corresponding to the category A. If the system information comprises the extended access barring parameters corresponding to the category A, the UE of the category C applies the extended access barring parameters corresponding to the category A; if the system information doesn't comprise the extended access barring parameters corresponding to the category A, the UE needs to match the access class barred parameters.

Step 108: the UE determines whether the result of the second match is the extended access barring parameters, if yes, the UE implements the step 109; otherwise implements step 111.

Step 109: the UE implements the access determination based on the extended access barring parameters. Since the extended access barring parameters comprise the information of barred or not barred for different access classes, the UE checks the corresponding information of barred or not barred according to its access class.

Step 110: the UE determines whether the result of implementing the access determination based on extended access barring is barred: if the UE finds the result of the access determination based on the extended access barring parameters is barred, the UE can't initiate random access, the access control of the UE fails, the AS of the UE needs to inform its NAS of the information that the access determination is barred (or called as failure) according to extended access barring; if the UE finds the determining result according to extended access barring is not barred, then implements the step 111.

Step 111: the UE implements the access determination based on the access class barred parameters. Here it needs to note that since the access class barred parameters comprise access class barring for mobile initiating services (ac-BarringForMO-Data) and access class barring for mobile initiating signaling (ac-BarringForMO-Signalling), the UE may randomly select one of them to implement the access determination. Such as that the UE may select ac-BarringForMO-Data to implement the access determination, and this part is a current mechanism and will not be described here. If the access determination based on the access class barred parameters, implemented by the UE, is barred, the access control of the UE fails, and the AS of the UE needs to inform its NAS of the information that the access determination based on access class barred is barred; if the access determination based on the access class barred parameters implemented by the UE is not barred, the UE may initiate random access and establish RRC to conduct services.

In this embodiment, the UE has the valid AC 11, and the UE checks if the first bit of ac-BarringForSpecialAC is 0 (or not barred). The ac-BarringForSpecialAC comprises five bits in total, which configure barring parameters respectively for AC 11˜15: if the access barring parameter corresponding to AC 11 is 0, the UE considers the current cell is not barred. The UE in the embodiment comprises an valid and unordinary access class (AC 11), while some UEs have multiple valid unordinary access classes, such as AC 12 and AC 14, then the UE needs to check the access barring parameters configured in ac-BarringForSpecialAC for AC 12 and AC 14, and only if at least one of the parameters is 0 (or not barred), the UE considers the current cell is not barred and can access the current cell.

The embodiment proposes the detailed flow chart of implementing access controls according to the extended access barring parameters, which enables the UE implement access control correctly according to the parameters configured by the network side, when accessing the network, which is beneficial for the network side to control the quantity and overload etc. of the UE accessing the network, thereby realizing the normal running of network and enabling the network serve more UEs that initiate delay tolerant services.

It needs to note that although the embodiment describes the access control process of the LTE, it also applies for UMTS.

### Detailed Embodiment 2

In the LTE system, the UE resides in the cell of the base station, and the UE is in an idle state. The USIM of the UE is configured with the valid extended access barring, besides, the USIM of the UE indicates the access class of the UE is 5, i.e. the access class is 5.

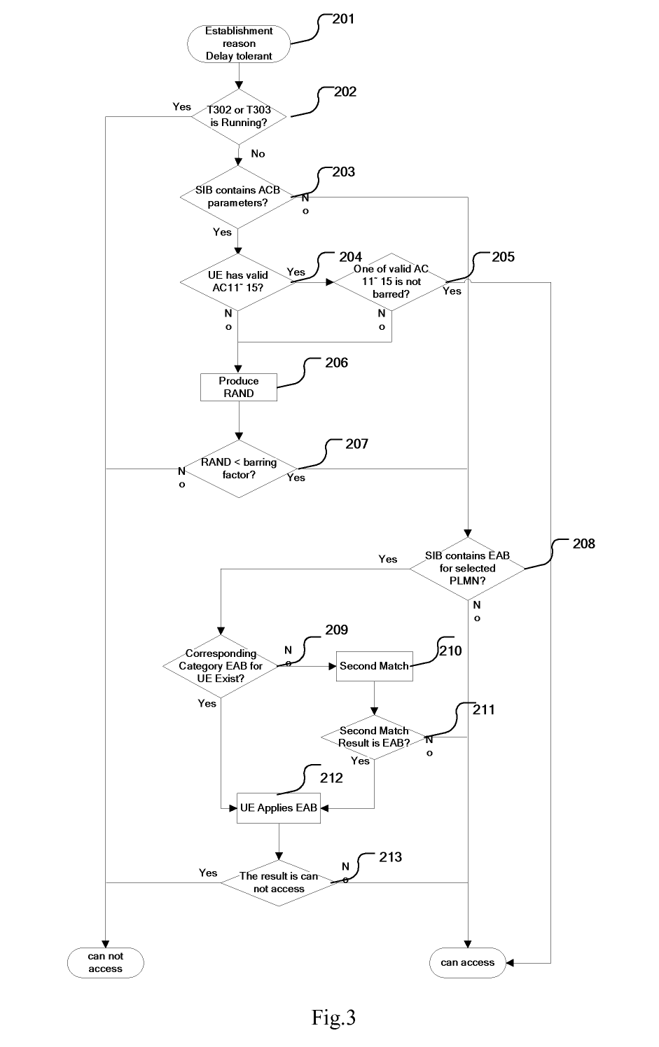

When the UE needs to initiate the delay tolerant service, the NAS of the UE sends to the AS of the UE an establishment cause of delay tolerance. The process of access determination implemented in the AS of the UE is illustrated as FIG. 3:

Step 201: the AS of the UE receives the service request of its NAS, and the establishment cause of the service is delay tolerance.

Step 202: the UE determines whether the waiting time timer (T302), or the access barring timer (T303) set for the data service initiated by the user is running, if running, the UE considers access to the cell as barred; if neither of the timers is running, the UE implements the step 203.

Step 203: the UE determines whether the system information comprises the access class barred parameters, which in this embodiment means the ac-BarringForMO-Data, if the system information doesn't comprise the parameter, the UE implements the step 209; if the system information comprises the parameter, the UE implements the step 204;

Step 204: whether the UE comprises valid unordinary access classes (i.e. one or multiple of AC 11˜15), if comprising, the UE implements the step 205; otherwise step 206.

Step 205: the UE checks whether the barring parameters for unordinary access classes (AC 11˜15) (ac-BarringForSpecialAC), comprised in the ac-BarringForMO-Data, comprises the 0-valued barring parameters corresponding to the unordinary access class (at least one of ac-BarringForMO-Data is 0), if yes, the UE considers it can access the current cell, or implements the step 206.

Here it needs to note that ac-BarringForSpecialAC comprises five bits in total, which configure ac-BarringForMO-Data respectively for AC 11˜15.

Step 206: the UE generates a random number RAND uniformly distributed between 0 and 1.

Step 207: the UE determines whether the RAND is less than ac-BarringFactor which is the parameter comprised in ac-BarringForMO-Data. If the RAND is less than ac-BarringFactor, the UE implements the step 208; otherwise the UE can't access the current cell. If the UE can't access the current cell, the UE needs to inform its NAS of the information that the access determination based on access class barred is barred (or called failure), when the NAS of the UE obtains the information, it determines the time to re-access the network (needing to wait for a long time, here it is called T1) to avoid the power consumption caused by continuously trying to access the network.

Step 208: the UE determines whether the system information block (SIB) comprises the extended access barring parameters corresponding to the network selected by the UE, or comprises the extended access barring parameters: if yes, the UE implements the step 209; otherwise the UE considers it can access the current cell.

Step 209˜step 213 are the same as the step 106˜110 in the embodiment 1. In these steps, if the UE finds the information that the access determination based on extended access barring is barred (or called failure), the UE needs to inform its NAS of the information that the access determination based on extended access barring is barred (or called failure), when the NAS of the UE obtains the information, it determines the time to re-access the network (needing to wait for a long time, here is called T2). Since the introduction of the extended access barring parameters is to control the UEs's initiating the delay tolerant service, and the UEs may be tolerant with larger delay, if the access determination based on the extended access barring parameters is barred, which means the network needs to bar the access of the UEs, the UEs needs to wait for more time, i.e. T2>T1, and the NAS of the UE needs to wait for more time to re-initiate the service request.

It needs to note that in the case of no conflict, the embodiments and the features of the embodiments in the application may combine with each other in any manner.

Certainly, the invention still has other multiple embodiments, without departing from the spirit and essence of the invention, those skilled in the art may make various kinds of corresponding changes and modifications according to the invention, but those corresponding changes and modifications should belong to the protection scope of the claims attached by the invention.

The ordinary skilled in the art may understand that all or partial of the steps in the above methods may be achieved by that programs instruct the related hardware, the programs may be stored in the computer readable storage medium, such as ROMs, disks or discs etc. Optionally, all or partial of the steps in the above embodiments may be achieved by one or multiple integrated circuits. Correspondingly, each module/unit in the above embodiments may be achieved as hardware, or software function modules. The invention is not limited in any specific form of the combination of hardware and software.

1. A method of implementing access controls in a UE, wherein, the method comprises:
determining whether the UE has a special access level which is valid and not barred—when having, determining that the UE can access a current cell;
determining whether a system information block comprises extended access barring parameters of the UE, when comprising:
determining whether the UE can access the current cell based on the extended access barring, according to the extended access barring parameters of the UE.

2. A method of claim 1, wherein, determining whether the UE can access the current cell based on the extended access barring, according to the extended access barring parameters of the UE comprises:
determining whether system information comprises the extended access barring parameters relevant with the category corresponding to the UE;
if not comprising, determining whether the system information comprises extended access barring parameters applicable for the UE;
if the determining result of the determining whether system information comprises the extended access barring parameters relevant with the category corresponding to the UE is comprising, or the determining result of the determining whether the system information comprises extended access barring parameters applicable for the UE is comprising, then applying the extended access barring parameters to determine whether the UE can access the current cell;
if the determining result of the determining whether the system information comprises extended access barring parameters applicable for the UE is not comprising, then determining that the UE can access the current cell.

3. A method of claim 2, wherein, the determining whether the system information comprises extended access barring parameters applicable for the UE comprises:
determining whether the system information comprises the extended access barring parameters covering the category corresponding to the UE.

4. A method of claim 1, wherein, the method comprises:
an access stratus receiving a service request from an upper stratus;
when the determining whether the UE can access the current cell based on the extended access barring, according to the extended access barring parameters of the UE determines that the UE can not access the current cell, the method comprises:
informing the upper stratus of the reason of refusing access based on the extended access barring.

5. A method of claim 1, wherein, when the determining result of the determining whether the UE has a special access level which is valid and not barred is not having, continuing the determining whether a system information block comprises extended access barring parameters of the UE, or determining whether the UE can access the current cell based on the extended access barring, according to the extended access barring parameters of the UE, or applying an access class barred (ACB) to determine whether the UE can access the current cell;
when the determining result of the determining whether a system information block comprises extended access barring parameters of the UE, step d is not having, continuing to apply the access class barred to determine whether the UE can access the current cell;
after the determining whether the UE can access the current cell based on the extended access barring, according to the extended access barring parameters of the UE determines the UE can access the current cell based on the extended access barring, continuing to apply the access class barred to determine whether the UE can access the current cell.

6. A method of claim 4, wherein, the method comprises:
applying an access class barred, and determining whether the UE can access the current cell based on the access class barred;
when determining that the UE can access, continuing the determining whether a system information block comprises extended access barring parameters of the UE;
when determining that the UE can not access, informing the upper stratus of the reason of refusing access based on the access class barred.

7. A method of claim 4, wherein, the upper stratus of the UE decides a minimum time for which re-initiating the service request needs to wait, according to the reason of refusing access,
wherein, the minimum time corresponding to refusing access based on the extended access barring is not less than the minimum time corresponding to refusing access based on the access class barred.

8. A method of claim 1, wherein, the method comprises the following steps before the determining whether the UE has a special access level which is valid and not barred—when having, determining that the UE can access a current cell:
determining whether an access timer is in a timing state;
when the access timer is not in the timing state, implementing the determining whether the UE has a special access level which is valid and not barred—when having, determining that the UE can access a current cell; otherwise, determining that the UE can not access the current cell;
wherein, the access timer comprises at least one timer of the following:
an waiting time timer;
an access barring timer, configured for delay tolerance services;
an access barring timer, configured for UE-initiated data services;
an access barring timer, configured for UE-initiated signaling services;

9. A method of claim 1, wherein, the UE comprises the UE applicable for the extended access barring, and the service request comprises delay tolerance services.

10. An access control module used in a UE, wherein, the access control module comprises the following components:
a first determining unit which is used for determining whether the UE has a special access level which is valid and not barred: when having, determining that the UE can access a current cell;
a second determining unit which is used for determining whether a system information block comprises extended access barring parameters of the UE;
a third determining unit which is used for determining whether the UE can access the current cell based on extended access barring, according to the extended access barring parameters of the UE, in case that the second determining unit determines comprising.

11. The access control module of claim 10, wherein, the third determining unit is further used for informing an upper stratus of the reason of refusing access based on the extended access barring, when the third determining unit determines that the UE can not access.

12. The access control module of claim 10, wherein, the access control module still comprises a fourth determining unit, which is used for applying an access class barred to determine whether the UE can access the current cell, and the fourth determining unit operates when any one of the following cases occurs:
the determining result of the first determining unit is not having;
the determining result of the second determining unit is not comprising; and
the third determining unit determines the UE can access the current cell based on the extended access barring.

13. The access control module of claim 10, wherein, the access control module still comprises a fourth determining unit, which is used for applying an access class barred to determine whether the UE can access the current cell;
when the fourth determining unit determines the UE can access, the second and third determining units continue operating; the fourth determining unit is used for informing an upper stratus of the reason of refusing access based on the access class barred, when determining that the UE can not access.

14. The access control module of claim 11,
wherein, the access control module decides a minimum time for which re-initiating the service request needs to wait, according to the reason of refusing access,
wherein, the minimum time corresponding to refusing access based on the extended access barring is not less than the minimum time corresponding to refusing access based on the access class barred.

15. A UE, wherein, the UE comprises an access control module according to claim 10.
